(19) United States
(12) Patent Application Publication
(10) Pub. No.: US 2020/0305420 A1
(43) Pub. Date: Oct. 1, 2020

(54) NEW AGROCHEMICAL PESTICIDE COMPOSITIONS

(71) Applicant: BASF SE, Ludwigshafen (DE)

(72) Inventors: Wen Xu, Research Triangle Park, NC (US); Yvonne Dieckmann, Ludwigshafen (DE); Antoine Levy, Research Triangle Park, NC (US); Kara Walden Benton, Research Triangle Park, NC (US); Karl-Heinrich Schneider, Limburgerhof (DE)

(21) Appl. No.: 16/652,106

(22) PCT Filed: Oct. 1, 2018
(86) PCT No.: PCT/EP2018/076555

§ 371 Date: Mar. 30, 2020

(30) Foreign Application Priority Data
Oct. 9, 2017 (EP) 17195449.8

(51) Int. Cl. A01N 25/10; A01N 61/00; A01N 59/00; A01N 37/22; A01N 43/56

(52) U.S. Cl. CPC A01N 25/10; A01N 61/00; A01N 43/56; A01N 37/22; A01N 59/00

(57) ABSTRACT

Agrochemical composition comprising: a) a pesticide, b) a thickener T, c) a polymer P, said polymer P being a homo- or copolymer of (meth)acrylic acid with an average molecular mass Mw of at least 150,000 Da, said composition being a suspension concentrate (SC) composition. The use of the composition for controlling pests as well as a method of controlling phytopathogenic fungi and/or undesired plant growth and/or undesired insect or mite attack and/or for regulating the growth of plants using the composition.

The present invention is directed to agrochemical compositions comprising
a) a pesticide,
b) a thickener T,
c) a polymer P, said polymer P being a homo- or copolymer of (meth)acrylic acid with an average molecular mass Mw of at least 150,000 Da.

A wide range of agrochemical compositions and composition additives are known. One problem of agrochemical compositions is their storage stability, especially in the presence of high concentrations of salts.

U.S. Pat. No. 8,937,054 discloses compositions comprising inter alia bifentrin, poly(meth)acrylic acid polymers and certain clays.

US 2016/0185680 discloses insecticide compositions comprising hydrophobically modified polyacrylate.

US 2012/0040827 discloses agrochemical compositions comprising an agrochemical active and a dispersant polymer comprising AMPS.

There is a continued need for agrochemical compositions having a high storage stability. The objective of the present invention was thus to provide agrochemical compositions with improved storage stability.

This objective was achieved by agrochemical compositions comprising
a) a pesticide,
b) a thickener T,
c) a polymer P, said polymer P being a homo- or copolymer of (meth)acrylic acid with an average molecular mass Mw of at least 150,000 Da.

Average molar masses Mw of polymers referred to herein are determined by gel permeation chromatography (GPC) according to the procedure given in the experimental section.

The term “a pesticide” shall be understood to mean that one or more pesticides can be comprised in said agrochemical composition.

The term pesticides refers to at least one active substance selected from the group of fungicides, insecticides, nematicides, herbicides, safeners, biopesticides and/or growth regulators. Preferably the term pesticides refers to at least one active substance selected from the group of the fungicides, insecticides, nematicides, herbicides, safeners and/or growth regulators. Preferred pesticides are fungicides, insecticides, herbicides and growth regulators. In one embodiment, the pesticide is an insecticide. In another embodiment, the pesticide is a fungicide. In yet another embodiment the pesticide is a herbicide. Mixtures of pesticides from two or more of the abovementioned classes may also be used.

The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

Suitable pesticides include the following, by way of example (pesticides A) to K) are fungicides):

A) Respiration inhibitors
complex-III-inhibitors at the Qₒ-site (for example strobilurins): azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, methyl 2-[2-(2,5-dimethylphenyloxymethyl)phenyl]-3-methoxyacrylate, 2-(2-(3-(2,6-dichlorophenyl)-1-methylallylideneaminooxymethyl)phenyl)-2-methoxyimino-N-methylacetamide, pyribencarb, triclopyricarb/chlorodincarb, famoxadon, fenamidon;
complex-III-inhibitors at the Qᵢ-site: cyazofamid, amisulbrom;
complex-II-inhibitors (for example carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethylbutyl)phenyl)-1,3-dimethyl-5-fluoro-1H-pyrazole-4-carboxamide and N-[9-(dichloromethylene)-1,2,3,4-tetrahydro-1,4-methanonaphthalen-5-yl]-3-(difluoromethyl)-1-methyl-1H-pyrazole-4-carboxamide;
other respiration inhibitors (for example complex I, decouplers): diflumetorim; nitrophenyl derivatives: binapacryl, dinobuton, dinocap, fluazinam; ferimzone; organometal compounds: fentin salts such as fentin acetate, fentin chloride or fentine hydroxide; ametoctradin; and silthiofam;

B) Sterol biosynthesis inhibitors (SBI fungicides)
C14-demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, mefentrifluconazol, triflumizole; pyrimidines, pyridines and piperazines: fenarimol, nuarimol, pyrifenox, triforine;
delta14-reductase inhibitors: aldimorph, dodemorph, dodemorph acetate, fenpropimorph, tridemorph, fenpropidin, piperalin, spiroxamine;
3-ketoreductase inhibitors: fenhexamid;

C) Nucleic acid synthesis inhibitors
phenylamides or acylamino acid fungicides: benalaxyl, benalaxyl-m, kiralaxyl, metalaxyl, metalaxyl-M (mefenoxam), ofurace, oxadixyl;
others: hymexazole, octhilinone, oxolinic acid, bupirimate;

D) Cell division and cytoskeleton inhibitors
tubulin inhibitors such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine;
further cell division inhibitors: diethofencarb, ethaboxam, pencycuron, fluopicolid, zoxamid, metrafenon, pyriofenon;

E) Amino acid synthesis and protein synthesis inhibitors
methionine synthesis inhibitors (anilinopyrimidines): cyprodinil, mepanipyrim, pyrimethanil;
protein synthesis inhibitors: blasticidin-S, kasugamycin, kasugamycin hydrochloride hydrate, mildiomycin, streptomycin, oxytetracyclin, polyoxin, validamycin A;

F) Signal transduction inhibitors
MAP/histidine kinase inhibitors: fluoroimide, iprodione, procymidone, vinclozolin, fenpiclonil, fludioxonil;
G-protein inhibitors: quinoxyfen;

G) Lipid and membrane synthesis inhibitors
phospholipid biosynthesis inhibitors: edifenphos, iprobenfos, pyrazophos, isoprothiolane;
lipid peroxidation: dicloran, quintozene, tecnazene, tolclofos-methyl, biphenyl, chloroneb, etridiazole;
phospholipid biosynthesis and cell wall attachment: dimethomorph, flumorph, mandipropamid, pyrimorph, benthiavalicarb, iprovalicarb, valifenalate and 4-fluorophenyl N-(1-(1-(4-cyanophenyl)ethanesulfonyl)but-2-yl)carbamate;
compounds which affect cell membrane permeability and fatty acids: propamocarb, propamocarb hydrochloride

H) “Multi-site” inhibitors
inorganic active substances: Bordeaux mixture, copper acetate, copper hydroxide, copper oxychloride, basic copper sulfate, sulfur;
thio- and dithiocarbamates: ferbam, mancozeb, maneb, metam, metiram, propineb, thiram, zineb, ziram;
organochlorine compounds (for example phthalimides, sulfamides, chloronitriles): anilazine, chlorothalonil, captafol, captan, folpet, dichlofluanid, dichlorophen, flusulfamide, hexachlorobenzene, pentachlorophenol and its salts, phthalid, tolylfluanid, N-(4-chloro-2-nitrophenyl)-N-ethyl-4-methyl benzenesulfonamide;
guanidines and others: guanidine, dodine, dodine-free base, guazatin, guazatin acetate, iminoctadin, iminoctadin triacetate, iminoctadin tris(albesilate), dithianon;

I) Cell wall biosynthesis inhibitors
glucan synthesis inhibitors: validamycin, polyoxin B; melanin synthesis inhibitors: pyroquilon, tricyclazole, carpropamid, dicyclomet, fenoxanil;

J) Resistance inductors
acibenzolar-S-methyl, probenazol, isotianil, tiadinil, prohexadione-calcium; phosphonates: fosetyl, fosetyl-aluminum, phosphorous acid and its salts;

K) Unknown mode of action
quinomethionate, cyflufenamid, cymoxanil, dazomet, debacarb, diclomezin, difenzoquat, difenzoquat-methyl sulfate, diphenylamine, fenpyrazamine, flumetover, flusulfamid, flutianil, methasulfocarb, nitrapyrin, nitrothal-isopropyl, oxine-copper, proquinazid, tebufloquin, tecloftalam, triazoxide, 2-butoxy-6-iodo-3-propylchromene-4-one, N(cyclopropylmethoxyimino-(6-difluoromethoxy-2,3-difluorophenyl)methyl)-2-phenylacetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)phenyl)-Nethyl-N-methylformamidine, N′-(5-difluoromethyl-2-methyl-4-(3-trimethylsilanylpropoxy)phenyl)-N-ethyl-N-methylformamidine, N-methyl-(1,2,3,4-tetrahydronaphthalen-1-yl)-2-{1-[2-(5-methyl-3-trifluoromethylpyrazol-1-yl)acetyl]piperidin-4-yl}thiazole-4-carboxamide, N-methyl-(R)-1,2,3,4-tetrahydronaphthalen-1-yl 2-{1-[2-(5-methyl-3-trifluoromethylpyrazol-1-yl)acetyl]piperidin-4-yl}thiazole-4-carboxamide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, 6-tert.-butyl-8-fluoro-2,3-dimethylquinolin-4-yl methoxyacetate, N-methyl-2-{1-[(5-methyl-3-trifluoromethyl-1H-pyrazol-1-yl)acetyl]piperidin-4-yl}-N-[(1R)-1,2,3,4-tetrahydronaphthalen-1-yl]-4-thiazolecarboxamide, 3-[5-(4-methylphenyl)-2,3-dimethylisoxazolidin-3-yl]-pyridine, 3-[5-(4-chlorophenyl)-2,3-dimethylisoxazolidin-3-yl]-pyridine (pyrisoxazol), N-(6-methoxypyridin-3-yl) cyclopropanecarboxamide, 5-chloro-1-(4,6-dimethoxypyrimidin-2-yl)-2-methyl-1H-benzoimidazole, 2-(4-chlorophenyl)-N-[4-(3,4-dimethoxyphenyl)isoxazol-5-yl]-2-prop-2-ynyloxyacetamide;

M) Growth regulators
abscisic acid, amidochlor, ancymidole, 6-benzylaminopurine, brassinolide, butralin, chlormequat (chlormequat chloride), choline chloride, cyclanilid, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidid, mepiquat (mepiquat chloride), metconazole, naphthaleneacetic acid, N-6-benzyladenine, paclobutrazole, prohexadione (prohexadione-calcium), prohydrojasmone, thidiazuron, triapenthenol, tributylphosphorotrithioate, 2,3,5-triiodobenzoic acid, trinexapac-ethyl and uniconazole;

N) Herbicides
acetamides: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor;
amino acid analogs: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
bipyridyls: diquat, paraquat;
carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bromoxynil, dichlobenil, ioxynil;
imidazolinones: imazamethabenz, imazamox, imazapic, imazapyr, imazaquin, imazethapyr;
phenoxyacetic acids: clomeprop, 2,4-dichlorophenoxyacetic acid (2,4-D), 2,4-DB, dichlorprop, MCPA, MCPA-thioethyl, MCPB, mecoprop;
pyrazines: chloridazon, flufenpyr-ethyl, fluthiacet, norflurazon, pyridate;
pyridines: aminopyralid, clopyralid, diflufenican, dithiopyr, fluridone, fluroxypyr, picloram, picolinafen, thiazopyr;
sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl)sulfonyl)-3-(4,6-dimethoxypyrimidin-2-yl)urea;
triazines: ametryne, atrazine, cyanazine, dimethametryne, ethiozine, hexazinone, metamitron, metribuzine, prometryne, simazine, terbuthylazine, terbutryne, triaziflam;
ureas: chlortoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam;
others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethyl, chlorthal, cinmethylin, clomazone, cumyluron, cyprosulfamid, dicamba, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, ternbotrione, thiencarbazone, topramezone, 4-hydroxy-3-[2-(2-methoxyethoxymethyl)-6-trifluoromethylpyridin-3-carbonyl]bicyclo[3.2.1]oct-3-en-2-one, ethyl (3-[2-chloro-4-fluoro-5-(3-methyl-2,6-dioxo-4-trifluoromethyl-3,6-dihydro-2H-pyrimidin-1-yl)phenoxy]pyridin-2-yloxy)acetate, methyl 6-amino-5-chloro-2-cyclopropylpyrimidine-4-carboxylate, 6-chloro-3-(2-cyclopropyl-6-methylphenoxy)pyridazin-4-ol, 4-amino-3-chloro-6-(4-chlorophenyl)-5-fluoropyrid in-2-carboxylic acid, methyl 4-amino-3-chloro-6-(4-chloro-2-fluoro-3-methoxyphenyl)pyridin-2-carboxylate and methyl 4-amino-3-chloro-6-(4-chloro-3-dimethylamino-2-fluorophenyl)pyridin-2-carboxylate;

O) Insecticides
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methylparathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alphacypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin,
insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazin; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;
nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl[1,3,5]triazinane;
GABA antagonists: endosulfan, ethiprole, fipronil, vaniliprole, pyrafluprole, pyriprole, N-5-amino-1-(2,6-dichloro-4-methylphenyl)-4-sulfinamoyl-1H-pyrazole-3-thiocarboxamide;
macrocyclic lactones: abamectin, emamectin, milbemectin, lepimectin, spinosad, spinetoram;
mitochondrial electron transport chain inhibitor (METI) I acaricides: fenazaquin, pyridaben, tebufenpyrad, tolfenpyrad, flufenerim;
METI II and III substances: acequinocyl, fluacyprim, hydramethylnone;
decouplers: chlorfenapyr;
inhibitors of oxidative phosphorylation: cyhexatin, diafenthiuron, fenbutatin oxide, propargite;
insect ecdysis inhibitors: cryomazine;
‘mixed function oxidase’ inhibitors: piperonyl butoxide;
sodium channel blockers: indoxacarb, metaflumizone;
others: benclothiaz, bifenazate, cartap, flonicamid, pyridalyl, pymetrozin, sulfur, thiocyclam, flubendiamide, chlorantraniliprole, cyazypyr (HGW86); cyenopyrafen, flupyrazofos, cyflumetofen, amidoflumet, imicyafos, bistrifluron and pyrifluquinazone.

In one preferred embodiment, the pesticide has a solubility in water of less than 1 g/l at 23° C.

In one embodiment, the pesticide is selected from broflanilide, pyraclostrobin and fluxapyroxad or mixtures thereof.

Thickeners are compounds that impart a modified flow behavior to the composition, i.e. high viscosity at rest and low viscosity in the agitated state.

Thickener T is preferably an attapulgite clay or hydrophilic fumed silica.

In one embodiment thickener T is an attapulgite clay.

Polymers P are homo- or copolymers of (meth)acrylic acid.

“(meth)acrylic acid” shall mean acrylic acid and/or methacrylic acid.

When reference is made herein to (meth)acrylic acid or other carboxylic acid as monomeric units in polymers, this shall be understood to mean the carboxylic per se as well it salts of such carboxylic acid.

According to the invention, polymers P have an average molar mass MW of at least 150,000 Da.

All average molar masses Mw referred to herein are determined by gel permeation chromatography as described in the experimental section.

Preferably, polymers P have an average molar mass MW of at least 200,000 Da.

Even more preferably polymers P have an average molar mass MW of at least 225,000 Da.

In one embodiment, polymer P is a homopolymer or a copolymer of methacrylic acid or its salts.

In one embodiment, polymer P is a homopolymer or a copolymer of acrylic acid or its salts.

In one embodiment, polymer P is a homopolymer of acrylic acid or its salts

In one embodiment, polymer P is a copolymer of acrylic acid or its salts with other monomers M having ethylenically unsaturated double bonds. Suitable monomers M include vinylaromatic monomers such as styrene and styrene derivatives, such as α-methylstyrene, vinyltoluene, ortho-, meta- and para-methylstyrene, ethylvinylbenzene, vinylnaphthalene, vinylxylene and the corresponding halogenated vinylaromatic monomers, vinylaromatic monomers which bear nitro, alkoxy, haloalkyl, carbalkoxy, carboxy, amino and alkylamino groups, α-olefins, such as ethene, propene, 1-butene, 1-pentene, 1-hexene, isobutene, long-chain (C10-C20)-alkyl-α-olefins, dienes such as butadiene and isoprene, vinyl alcohol esters such as vinyl acetate, vinyl halides such as vinyl chloride, vinyl bromide, vinyl fluoride, vinylidene chloride, vinylidene fluoride, vinylidene bromide, vinylnitrile, vinyl carboxylates, 1-vinylamides such as 1-vinylpyrrolidone, 1-vinylpiperidone, 1-vinylcaprolactam, N-vinylimidazole, C₁-C₂₄-alkylesters and monosubstituted and disubstituted and unsubstituted C₁- to C₂₄-alkylamides of monoethylenically unsaturated monomers such as acrylic acid, methacrylic acid, fumaric acid, maleic acid and itaconic acid, vinylsulfonic acid, anhydrides such as maleic anhydride, unsaturated aldehydes such as acrolein, unsaturated ethers such as 1,4-cyclohexanedimethanol divinyl ether, 1,4-cyclohexanedimethanol monovinyl ether, butanediol divinyl ether, butanediol monovinyl ether, cyclohexyl vinyl ether, diethylene glycol divinyl ether, ethylene glycol monovinyl ether, ethyl vinyl ether, methyl vinyl ether, n-butyl vinyl ether, octadecyl vinyl ether, triethylene glycol vinyl methyl ether, vinyl isobutyl ether, vinyl 2-ethylhexyl ether, vinyl propyl ether, vinyl isopropyl ether, vinyl dodecyl ether, vinyl tert.-butyl ether, hexandiol divinyl ether, hexandiol monovinyl ether, diethylene glycol monovinyl ether, diethylaminoethyl vinyl ether, polytetrahydrofuran-290 divinyl ether, tetraethylene glycol divinyl ether, triallylamine, ethylene glycol butyl vinyl ether, ethylene glycol divinyl ether, triethylene glycol divinyl ether, trimethylolpropane trivinyl ether, aminopropyl vinyl ether. Preferred further monomers are those having at least two olefinically unsaturated double bonds, such as triallylamine.

Preferred monomers M are fumaric acid, maleic acid, itaconic acid, vinylsulfonic acid, 2-acrylamido-2-methyl-1-propanesulfonic acid maleic anhydride, acrylamide, N-vinyl pyrrolidone.

In each case when reference is made to an acid like a carboxylic acid or a sulfonic acid as a monomer, this shall also include their respective salts.

In one preferred embodiment, polymer P is a homopolymer of acrylic acid with an average molar mass Mw of at least 150,000 Da, more preferably 200,000 Da, even more preferably 225,000 Da.

Polymer P is usually synthesized in the usual manner by means of free-radical polymerization. However, it is also possible to employ other processes for the polymerization, for example controlled free-radical processes. The polymerization is carried out in the presence of the monomers and of one or more initiators and can be carried out with or without solvent, in emulsion or in suspension. The polymerization can be carried out as a batch reaction, as a semicontinuous operation or as a continuous operation. The reaction times are generally in the range of between 1 and 12 hours. The temperature range within which the reactions can be carried out is generally from 20 to 200° C., preferably from 40 to 120° C.

The initiators which are employed for the free-radical polymerization are customary free-radicalforming substances. The initiator is preferably selected from the group of the azo compounds, of the peroxide compounds or of the hydroperoxide compounds. Examples that may be stated include acetyl peroxide, benzoyl peroxide, lauroyl peroxide, tert.-butyl peroxyisobutyrate, caproyl peroxide, cumene hydroperoxide, azobisisobutyronitrile or 2,2-azobis(2-methylbutane)nitrile. Particularly preferred is azobisisobutyronitrile (AIBN).

The free-radical polymerization for making polymer P is preferably carried out in solution. Solvents are water, alcohols such as, for example, methanol, ethanol, propanol, dipolar-aprotic solvents such as, for example, DMF, DMSO or NMP, aromatic, aliphatic, halogenated or nonhalogenated hydrocarbons such as, for example, hexane, chlorobenzene, toluene or benzene. Preferred solvents are water, isopropanol, methanol, toluene, DMF, NMP, DMSO and hexane.

Polymer P is usually soluble in water, for example to at least 5 g/l at 20° C. (preferably to at least 20 g/l, in particular at least 50 g/l).

Compositions according to the invention usually comprise at least 0.1% by weight, preferably at least 1% by weight and in particular at least 2% by weight of polymer P. Compositions according to the invention usually comprise from 0.1 to 25% by weight, preferably from 0.5 to 10% by weight and in particular from 1 to 5% by weight of polymer P.

The weight ratio of pesticide to polymer P can vary within any range, for example in the range of from 1:10 000 to 10 000:1, preferably in the range of from 1:1000 to 1000:1, especially preferably in the range of from 1:100 to 100:1.

Agrochemical compositions according to the invention can in principle be prepared at any pH. Preferably, agrochemical compositions according to the invention have a pH below 9, more preferably from 4 to 8.

As has been described above, compositions according to the invention comprise a thickener T in combination with a polymer P. As it was found quite unexpectedly, the inclusion of polymers P with a molar mass MW below 150,000 Da lead to a reduced or similar viscosity of the composition obtained as compared over compositions comprising only a thickener T and no polymer P.

However, if a polymer P with a molar mass of at least 150,000 Da is included in such composition, a composition with an increased viscosity is obtained.

In one embodiment, compositions according to the inventions further comprise a fertilizer F. Fertilizer F is liquid, meaning that it is present not as a solid but in liquid phase. Normally, fertilizer F is dissolved in the composition or in one phase of the composition. Fertilizer F is normally water soluble.

Water-soluble fertilizer F is in most cases soluble in water to more 10 g/l at 20° C. Preferably, it is soluble in water to more than 50 g/l, in particular more than 100 g/l. The skilled worker can simply select fertilizers with a suitable solubility from the above fertilizer list. Preferred fertilizers F are sulfates, phosphates or nitrates, in particular ammonium sulfate, ammonium nitrate, and/or ammonium polyphosphate (e.g. 10-34-0, see experimental section for explanation of the fertilizer grade).

In one embodiment, compositions according to the invention comprise fertilizers F in an amount of 5 to 99%, based on the composition.

In one embodiment, compositions according to the invention may further comprise nitrification inhibitors and/or urease inhibitors.

Suitable nitrification inhibitors are in principle all compounds capable of reducing the activity of bacteria in the nitrification process.

Preferably, nitrification inhibitors are selected from pyrazoles like 3,4-dimethyl-1-H-pyrazol (DMP), 3,4-dimethyl-1-H-pyrazole succinic (DMPSA) or 3,4-dimethylpyrazol phosphate (DMPP); 2-Chloro-6-(trichloromethyl)pyridine (Nitrapyrin); dicyandiamide (DCD); ammoniumthiosulfate, or mixtures thereof.

Preferably nitrification inhibitors are selected from nitrapyrin, DMP, DMPP or mixtures thereof.

Examples of suitable urease inhibitors are phenylphosphoric acid diamide (PPD), monophenoxyphosphacen, thiourea, hydroxyurea, N-(n-butyl) thiophosphoric triamide (NBPT), N-(n-propyl) thiophosphoric triamide (NPPT).

Preferred urease inhibitors are NBPT and NPPT.

In one embodiment, compositions according to the invention comprise nitrification inhibitors and/or urease inhibitors in an amount of 0.01 wt % to 5 wt %, based on the composition.

The composition according to the invention is preferably present in the form of an agrochemical composition. Usual types of agrochemical compositions are, for example, solutions, emulsions, suspensions, dusts, powders, pastes and granules. Examples of types of compositions here are suspensions (SC, OD, FS), emulsifiable concentrates (EC), emulsions (EW, EO, ES), pastes, pills, wettable powders or dusts (WP, SP, SS, WS, DP, DS) or granules (GR, FG, GG, MG), which can either be soluble or dispersible (wettable) in water, and gels for the treatment of plant propagation materials such as seed (GF). The agrochemical compositions are prepared in the known manner (see for example Mollet, H. and Grubemann, A.: Composition technology (Wiley VCH Verlag, Weinheim, 2001)).

In one preferred embodiment the composition according to the invention is a suspension concentrate.

The agrochemical compositions can furthermore also comprise conventional adjuvants which are conventionally used for plant protection products, the choice of the adjuvants depending on the specific use form or the pesticide. Examples of suitable adjuvants are solvents, solid carriers, surface-active substances (such as further solubilizers, protective colloids, wetters and adhesives), organic and inorganic thickeners, bactericides, antifreeze agents, antifoams, optionally colorants and stickers (for example for the treatment of seed).

Suitable solvents are water, organic solvents such as mineral oil fractions of medium to high boiling point such as kerosene, and diesel oil, furthermore coal tar oils and oils of vegetable or animal origin, aliphatic, cyclic and aromatic hydrocarbons, for example paraffins, tetrahydronaphthalene, alkylated naphthalenes and their derivatives, alkylated benzenes and their derivatives, alcohols such as methanol, ethanol, propanol, butanol and cyclohexanol, glycols, ketones such as cyclohexanone, gamma-butyrolactone, dimethyl fatty acid amides, fatty acids and fatty acid esters and strongly polar solvents, for example amines such as N-methylpyrrolidone. In principle, it is also possible to use solvent mixtures and mixtures of the abovementioned solvents and water.

Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas and products of vegetable origin such as cereal meal, tree bark meal, wood meal and nutshell meal, cellulose powders or other solid carriers.

Suitable surface-active substances (adjuvants, wetters, adhesives, dispersants or emulsifiers) are the alkali, alkaline-earth, ammonium salts of aromatic sulfonic acids, for example of lignosulfonic acid (Borresperse® types, Borregaard, Norway), phenolsulfonic acid, naphthalenesulfonic acid (Morwet® types, Akzo Nobel, USA) and dibutylnaphthalenesulfonic acid (Nekal® types, BASF, Germany), and of fatty acids, alkyl- and alkylarylsulfonates, alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ethers, ethoxylated isooctyl-, octyl- or nonylphenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin sulfite waste liquors and proteins, denatured proteins, polysaccharides (for example methylcellulose), hydrophobic-modified starches, polyvinyl alcohol (Mowiol® types, Clariant, Switzerland), polycarboxylates (Sokalan® types, BASF, Germany), polyalkoxylates, polyvinylamine (Lupamin® types, BASF, Germany), polyethyleneimine (Lupasol® types, BASF, Germany), polyvinylpyrrolidone and their copolymers.

Bactericides may be added to stabilize the composition. Examples of bactericides are those based on dichlorophene and benzyl alcohol hemiformal (Proxel® from ICI or Acticide® RS from Thor Chemie and Kathon® MK from Rohm & Haas) and also isothiazolinone derivatives such as alkylisothiazolinones and benzisothiazolinones (Acticide® MBS from Thor Chemie). Examples of suitable antifreeze agents are ethylene glycol, propylene glycol, urea and glycerol. Examples of antifoams are silicone emulsions (such as, for example, Silikon® SRE, Wacker, Germany, or Rhodorsil®, Rhodia, France), long-chain alcohols, fatty acids, salts of fatty acids, organofluorine compounds and their mixtures. Examples of colorants are pigments, which are sparingly soluble in water, but also dyes, which are soluble in water. Examples of stickers are polyvinylpyrrolidone, polyvinyl acetate, polyvinyl alcohol and cellulose ethers (Tylose®, Shin-Etsu, Japan).

The composition according to the invention is preferably in the form of an aqueous composition (such as suspension concentrates SC), where the water-insoluble pesticide is present in the form of suspended particles. The water content may be at least 10% by weight, preferably at least 30% by weight. The suspended particles may be present in the form of crystalline or amorphous particles which are solid at 20° C. The suspended water-insoluble pesticide usually has a particle size distribution with an x₅₀ value of from 0.1 to 10 μm, preferably 0.2 μm to 5 μm and especially preferably 0.5 μm to 2 μm. The particle size distribution can be determined by laser light diffraction of an aqueous suspension comprising the particles. The sample preparation, for example the dilution to the measuring concentration, will, in this measuring method, depend on the fineness and concentration of the pesticide in the suspension sample and on the apparatus used (for example Malvern Mastersizer), inter alia. The procedure must be developed for the system in question and is known to a person skilled in the art.

The pesticide concentrations in the ready-to-use preparations can be varied within substantial ranges. In general, they are between 0.0001 and 10%, preferably between 0.01 and 1%. The pesticides can also be used successfully in the ultra-low-volume method (ULV), it being possible to apply compositions with more than 95% by weight of pesticide, or indeed the pesticide without additives. For use in plant protection, the application rates are between 0.001 and 2.0 kg of pesticide per ha, preferably between 0.005 and 2 kg per ha, especially preferably between 0.05 and 0.9 kg per ha, in particular between 0.1 and 0.75 kg per ha, depending on the nature of the desired effect. When treating plant propagation materials, for example seed, amounts of pesticide of from 0.1 to 1000 g/100 kg of propagation material or seed, preferably from 1 to 1000 g/100 kg, especially preferably from 1 to 100 g/100 kg, in particular from 5 to 100 g/100 kg, will generally be used. When used in the protection of materials or storage materials, the application rate of pesticide depends on the nature of the field of application and on the desired effect. Conventional application rates in the protection of materials are, for example, from 0.001 g to 2 kg, preferably from 0.005 to 1 kg, of poesticide per cubic meter of treated material.

Substances which may be admixed to the pesticides or to the compositions comprising them include various types of oils, or wetters, adjuvants, herbicides, bactericides, other fungicides and/or pesticides, optionally also only just before use (tank mix). These agents can be admixed to the compositions according to the invention in the weight ratio 1:100 to 100:1, preferably 1:10 to 10:1. Adjuvants in this sense which are suitable are, in particular: organically modified polysiloxanes, for example Break Thru S 240®; alcohol alkoxylates, for example Atplus® 245, Atplus® MBA 1303, Plurafac® LF 300 and Lutensol® ON 30; EO-PO block polymers, for example Pluronic® RPE 2035 and Genapol® B; alcohol ethoxylates, for example Lutensol® XP 80; and sodium dioctylsulfosuccinate, for example Leophen® RA.

A further subject is a method of preparing the composition according to the invention by bringing polymer P, thickener T and the pesticide into contact, for example by mixing. The abovementioned auxiliaries can optionally also be brought into contact with the composition. Further preparation methods for various types of compositions are as described above.

A further object is the use of the polymers P for dispersing pesticides. Preferred pesticides are as described above.

The present invention furthermore relates to a method of controlling phytopathogenic fungi and/or undesirable vegetation and/or undesired insect or mite attack and/or for regulating the growth of plants, wherein the composition according to the invention is allowed to act on the respective pests, their environment or the crop plants to be protected from the respective pest, on the soil and/or on undesired plants and/or on the crop plants and/or on their environment. The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant's properties. Such genetic modifications also comprise posttranslational modifications of proteins, oligo- or polypeptides, for example by means of glycosylation or binding of polymers such as, for example, prenylated, acetylated or farnesylated residues or PEG residues.

Advantages of the present invention are, inter alia, that it makes a high storage stability of the formulation possible; that the particle size growth of dispersed pesticides is slowed down or suppressed; that the agglomeration of dispersed pesticide particles is slowed down or suppressed; that the settling of dispersed pesticides is slowed down or suppressed; that the abovementioned advantages are also attained in the presence of high salt concentrations.

The examples which follow illustrate the invention without imposing any limitation.

### EXAMPLES

Materials Used:

| Polymer | Chemical structure | MW (Da) |
|---|---|---|
| Polymer 1 | Maleic acid-acrylic | 3000 |
| | acid copolymer | |
| Polymer 2 | Modified polyacrylic | 4000 |
| | acid, sodium salt | |
| Polymer 3 | Maleic acid-olefin | 12000 |
| | copolymer, sodium | |
| | salt | |
| Polymer 4 | Maleic acid-acrylic | 50000 |
| | acid copolymer, | |
| | sodium salt | |
| Polymer 5 | Maleic acid-acrylic | 70000 |
| | acid copolymer, | |
| | sodium salt | |
| Polymer 6 | Polyacrylates | 1200 |
| Polymer 7 | Polyacrylates partially | 4000 |
| | neutralize | |
| Polymer 8 | polyacrylates | 8000 |
| Polymer 9 | Polyacrylic acid | 100000 |
| Polymer 10 | Polyacrylic acid | 250000 |
| Polymer 11 | Maleic/acrylic acid | 20000 |
| | copolymer | |
| Polymer 12 | Polyacrylate, Na-Salt | 15000 |
| | homopolymer | |
| Polymer 13 | Polyacrylate, Na-Salt | 8000 |
| | homopolymer | |
| Polymer 14 | polyacrylate sulfonate | 15000 |
| | modified comb | |

Auxiliary 1: Alkyl Polyglycoside

Auxiliary 2: Polydimethylsiloxane antifoam, emulsion in water

Auxiliary 3: Mixture, containing 5-Chloro-2-methyl-2H-isothiazol-3-one and 2-Methyl-2H-isothiazol-3-one (3:1)

Auxiliary 4: 1,2-benzisothiazol-3(2H)-one

Auxiliary 5: Bronopol

Auxiliary 6: a low viscosity, water based dispersion of hydrophilic fumed silica with a slightly alkaline pH

Thickener 1: an inert powdered gelling grade of attapulgite. It is finely pulverized to effectively form colloidal gels in ionic and non-ionic aqueous solutions to provide thixotropic thickening and suspension.

Fertilizers are referred to herein using the fertilizer grade. All fertilizer labels comprise three numbers. The first number is the amount of nitrogen (N), the second number is the amount of phosphate (P2O5) and the third number is the amount of potash (K2O). These three numbers represent the primary nutrients (nitrogen(N)-phosphorus(P)-potassium(K)). A 10-10-10 fertilizer contains 10 percent nitrogen, 10 percent phosphate and 10 percent potash.

Method for determining the MW of polymers used: All average molar masses Mw were determined by gel permeation chromatography. The column used was a hydrophilic vinylpolymer network column with a diameter of 7.8 mm and a length of 30 cm of the type TSKgel G3000PWXL. The column temperature was 35° C. The flow was 0.5 ml/min. The detector used was a differential refractometer (DRI) detector of the type DRI Agilent 1100. The solvent used was 0.01 mol/l Phosphate buffered (=10 Na₂HPO₄+1.8 KH₂PO₄+2.7 KCl+137 NaCl in mmol/L) pH=7.4 in distilled water with 0.01 M NaN₃. The calibration was obtained with narrow molecular weight sodium salt polyacrylic acids homopolymers (Na-PAA, molar mass range 1250-1'100'000 g/mol, Supplier PSS). Additional two standards from American Polymer Standards Corporation (900 g/mol, 1770 g/mol) were added to the calibration curve. Extrapolation was used to estimate the molecular weight distribution outside the range of these calibration standards with respect to the exclusion and permeation limits. Samples were dissolved in the GPC eluent prior to injection. Injection volume was 100 μl.

### Examples 1 to 14: Viscosity of Thickener/Polymer Compositions

A surfactant-thickener interaction testing was carried out. In this testing, a 3% suspension of Thickener 1 in water as mixed with 5% polymer solution in water at 95%:5% mass ratio. The clay solution was then mixed uniformly and viscosity at shear rate of 100 1/s was measured by rotational viscosimetry using cone (2 degree)/plate configuration at 20° C.

| Exp. | | | viscosity in 3% suspension of |
|---|---|---|---|
| No. | Polymer | MW (Da) | Thickener 1 (mPa · s) |
| 1 | Control - no polymer | | 18.9 |
| 2 | Polymer 2 | 4000 | 1.6 |
| 3 | Polymer 1 | 3000 | 26.4 |
| 4 | Polymer 11 | 20000 | 4.5 |
| 5 | Polymer 5 | 70000 | 1.6 |
| 6 | Polymer 14 | 15000 | 1.6 |
| 7 | Polymer 4 | 50000 | 1.9 |
| 8 | Polymer 3 | 12000 | 1.7 |
| 9 | Polymer 6 | 1200 | 1.6 |
| 10 | Polymer 7 | 4000 | 2.7 |
| 11 | Polymer 8 | 8000 | 1.5 |
| 12 | Polymer 12 | 15000 | 1.8 |
| 13 | Polymer 9 | 100000 | 111.0 |
| 14 | Polymer 10 | 250000 | 167.6 |

It was found that polymers with MW of at least 150 kDa (polymer 10) greatly enhance the viscosity of the composition comprising Thickener 1 while all other polymers show lower viscosities, in many cases similar viscosities compared to control experiment 1.

### Experiments 16 to 22: Viscosity of Solid Concentrate Agro Formulations

A similar testing was performed to show enhanced interaction between polymers with a hydrophilic fumed silica thickener. In this experiment, standard insecticide SC formulations with following ingredients were prepared:

| SC formulation | Concentration (w/w) |
|---|---|
| Broflanilide | 40.62% |
| Polymer P | 1.38% |
| Auxiliary 1 | 0.98% |
| Auxiliary 2 | 0.38% |
| Auxiliary 3 | 0.09% |
| Auxiliary 4 | 0.19% |
| Auxiliary 5 | 0.07% |
| Auxiliary 6 | 1.97% |
| Propylene glycol | 4.71% |
| DI water | 49.60% |

Various polymers were used for comparison purpose. The formulation viscosity at shear rate of 100 1/s was measured to illustrate the surfactant-thickener interaction.

| | | | Formulation |
|---|---|---|---|
| Exp. No. | Polymer | MW (Dalton) | viscosity (mPa · s) |
| 15 | Control - no polymer | | 16.5 |
| 16 | Polymer 1 | 3000 | 71.4 |
| 17 | Polymer 5 | 70000 | 53.9 |
| 18 | Polymer 3 | 12000 | 24.4 |
| 19 | Polymer 6 | 1200 | 39.4 |
| 20 | Polymer 8 | 8000 | 47.3 |
| 21 | Polymer 9 | 100000 | 142.2 |
| 22 | Polymer 10 | 250000 | 131 |

The experimental data clearly demonstrated that especially Polymer 10 enhanced formulation viscosity significantly compared to lower Mw polymers.

### Examples 23 to 29: Storage Stability

A physical storage stability testing of above formulations obtained in examples 16 to 22 was carried out. In this testing, formulations were kept at various storage conditions, i.e., −10° C., freeze/thaw cycle (temperature cycled from −10° C. to 30° C. every 48 hours), 0° C., 20° C., 40° C. and 54° C. for two weeks. % phase separation of formulation was evaluated after storage for physical stability comparison.

| Exp. | | % phase separation after two weeks storage | | | | | |
|---|---|---|---|---|---|---|---|
| No. | Polymer | −10° C. | FT | 0° C. | 20° C. | 40° C. | 54° C. |
| 23 | Polymer 10 | 0.00% | 6.00% | 0.00% | 0.00% | 0.00% | 0.00% |
| 24 | Polymer 9 | 0.00% | 0.00% | traces | 0.00% | 6%* | 6% |
| 25 | Polymer 8 | 0.00% | 21.28% | 30.43% | 34.09% | 43.48% | 45.65% |
| 26 | Polymer 6 | 0.00% | 20.83% | 4.08% | 25.45% | 31.58% | 35.19% |
| 27 | Polymer 1 | 0.00% | 6.67% | 0.00% | 3.85% | 20.83% | 24.49% |
| 28 | Polymer 5 | 10.42% | 17.31% | 28.00% | 31.25% | 40.43% | 37.78% |
| 29 | Polymer 3 | 18.75% | 23.40% | 14.89% | 28.57% | 50.00% | 40.43% |

The above experiment results clearly show formulations with polymers with MW of at least 150 k Daltons (Polymer 10) are much more stable, especially at higher temperatures.

### Example 30 to 31: Storage Stability

SC fertilizer compatibility testing was also performed for comparison. In this experiment, Broflanilide SC with following recipe was prepared:

| | Concentration | |
|---|---|---|
| SC formulation | (w/w) | Function |
| Broflanilide | 25.82% | pesticide |
| Polymer P | 3.00% | polymer stabilizer |
| Auxiliary 1 | 2.00% | wetting agent |
| Auxiliary 2 | 0.39% | antifoamer |
| Auxiliary 3 | 0.09% | biocide |
| Auxiliary 4 | 0.20% | biocide |
| Auxiliary 5 | 0.08% | biocide |
| Thickener 1 | 2.50% | hydrophilic silica thickener |
| Propylene glycol | 5.00% | Anti-freezer |
| Sodium Phosphate | 0.08% | pH buffer |
| Monobasic | | |
| Disodium Phosphate | 0.18% | pH buffer |
| Sodium Hydroxide | 1.01% | pH adjustor |
| DI water | 52.55% | diluent |

Two formulations with Polymer 10 (Example 30) and Polymer 13 (Example 31) as Polymer P were prepared. Then formulation fertilizer compatibility testing was carried out. In this testing, the above formulation was mixed with 3-18-18 fertilizer at 5% (formulation):95% (liquid fertilizer) wt/wt ratio in a glass tube. After mixing, the glass tube was kept on the lab bench for 24 hours at 20° C., visual observation of mixture phase separation was performed as an indicator of degree of fertilizer compatibility.

It was found that formulation prepared from Polymer 10 shows no sign of phase separation in this testing, while formulation with Polymer 13 was phase separated, indicating that the formulation stabilized by Polymer 10 was more fertilizer compatible.

### Example 32: Storage Stability and Compatibility of Pyraclostrobin Formulation

Pyraclostrobin SC (suspension concentrate) with following recipe was prepared:

| SC formulation | Concentration (w/w) | Function |
|---|---|---|
| Pyraclostrobin | 40.62% | pesticidet |
| Polymer 10 | 1.38% | polymer stabilizer |
| Auxiliary 1 | 0.98% | wetting agent |
| Auxiliary 2 | 0.38% | antifoamer |
| Auxiliary 3 | 0.09% | biocide |
| Auxiliary 4 | 0.19% | biocide |
| Auxiliary 5 | 0.07% | biocide |
| Auxiliary 6 | 1.97% | hydrophilic silica thickener |
| Propylene glycol | 4.71% | anti-freezer |
| DI water | 49.60% | diluent |

A physical storage stability testing of above formulation was carried out. In this testing, formulation was kept at various storage conditions, i.e., −10° C., freeze/thaw cycle (temperature cycled from −10° C. to 30° C. every 48 hours), 0° C., 20° C., 40° C. and 54° C. for two weeks. % phase separation of formulation was evaluated after storage. It was found that the above formulation is free of phase separation after two weeks storage at all above mentioned temperatures.

Formulation fertilizer compatibility testing was also carried out. In this testing, the pyraclostrobin formulation was mixed with fertilizer at 5% (formulation):95% (liquid fertilizer) ratio in a glass tube. Four fertilizers were tested: 3-18-18, 10-34-0, 2-6-16, and 3-18-18. After mixing, the glass tube was kept on the lab bench for 24 hours at 20° C.; visual observation of formulation phase separation was performed. If phase separation occurred, redispersing through 10 inversions of glass tube was performed. If the settlement was dispersible to uniform after inversion, then the formulation was judged as fertilizer compatible.

It was found the above Pyraclostrobin SC was compatible with all tested fertilizers.

### Example 33: Fluxapyroxad Fertilizer Formulation Based on Present Invention

Fluxapyroxad SC with following recipe was prepared:

| SC formulation | Concentration (w/w) | Function |
|---|---|---|
| Fluxapyroxad | 40.62% | pesticide |
| Polymer 10 | 1.38% | polymer stabilizer |
| Auxiliary 1 | 0.98% | wetting agent |
| Auxiliary 2 | 0.38% | antifoamer |
| Auxiliary 3 | 0.09% | biocide |
| Auxiliary 4 | 0.19% | biocide |
| Auxiliary 5 | 0.07% | biocide |
| Auxiliary 6 | 1.97% | hydrophilic silica thickener |
| Propylene glycol | 4.71% | anti-freezer |
| DI water | 49.60% | diluent |

A physical storage stability testing of above formulation was carried out. In this testing, formulation was kept at various storage conditions, i.e., −10° C., freeze/thaw cycle (temperature cycled from −10° C. to 30° C. every 48 hours), 0° C., 20° C., 40° C. and 54° C. for two weeks. % phase separation of formulation was evaluated after storage. It was found that the above formulation is free of phase separation after two weeks storage at all above mentioned temperatures, indicating formulation is physically stable.

Formulation fertilizer compatibility testing was also carried out. In this testing, formulation was mixed with fertilizer at 5% (formulation):95% (liquid fertilizer) ratio in a glass tube. Four fertilizers were tested: 3-18-18, 10-34-0, 2-6-16, and 3-18-18. After mixing, the glass tube was kept on the lab bench for 24 hours at 20° C.; visual observation of formulation phase separation was performed. If phase separation occurred, redispersing through 10 inversions of glass tube was performed. If the settlement was dispersible to uniform after inversion, then the formulation was judged as fertilizer compatible.

It was found the above Fluxapyroxad SC was compatible with all tested fertilizers.

### Example 34: Storage Stability and Compatibility of Broflanilide+Fluxapyroxad Fertilizer Compatible Formulation Based on Present Invention

Broflanilide+Fluxapyroxad SC with following recipe was prepared:

| SC formulation | Concentration (w/w) | Function |
|---|---|---|
| Broflanilide | 20.31% | pesticide |
| Fluxapyroxad | 20.31% | pesticide |
| Polymer 10 | 1.38% | polymer stabilizer |
| Auxiliary 1 | 0.98% | wetting agent |
| Auxiliary 2 | 0.38% | antifoamer |
| Auxiliary 3 | 0.09% | biocide |
| Auxiliary 4 | 0.19% | biocide |
| Auxiliary 5 | 0.07% | biocide |
| Auxiliary 6 | 1.97% | hydrophilic silica thickener |
| Propylene glycol | 4.71% | anti-freezer |
| DI water | 49.60% | diluent |

A physical storage stability testing of above formulation was carried out. In this testing, formulation was kept at various storage conditions, i.e., −10° C., freeze/thaw cycle (temperature cycled from −10° C. to 30° C. every 48 hours), 0° C., 20° C., 40° C. and 54° C. for two weeks. % phase separation of formulation was evaluated after storage. It was found that the above formulation is free of phase separation after two weeks storage at all above mentioned temperatures, indicating formulation is physically stable.

Formulation fertilizer compatibility testing was also carried out. In this testing, formulation was mixed with fertilizer at 5% (formulation):95% (liquid fertilizer) ratio in a glass tube. Four fertilizers were tested: 3-18-18, 10-34-0, 2-6-16, and 3-18-18. After mixing, the glass tube was kept on the lab bench for 24 hours at 20° C.; visual observation of formulation phase separation was performed. If phase separation occurred, redispersing through 10 inversions of glass tube was performed. If the settlement was dispersible to uniform after inversion, then the formulation was judged as fertilizer compatible.

It was found the above Broflanilide+Fluxapyroxad SC was compatible with all tested fertilizers.

1. Agrochemical composition comprising
a) a pesticide,
b) a thickener T,
c) a polymer P, said polymer P being a homo- or copolymer of (meth)acrylic acid with an average molecular mass Mw of at least 150,000 Da,
said composition being a suspension concentrate (SC) composition.

2. Composition according to claim 1, wherein thickener T is an attapulgite clay or a hydrophilic fumed silica.

3. Composition according to claim 1, wherein said polymer P is a homopolymer or a copolymer of acrylic acid or its salts.

4. Composition according to claim 1, wherein said polymer P has an average molecular mass Mw of at least 200,000 Da.

5. Composition according to claim 1, wherein said polymer P is a homopolymer of acrylic acid and its salts.

6. Composition according to claim 1, wherein said polymer P is a copolymer of acrylic acid and its salts.

7. Composition according to claim 1, further comprising
d) a fertilizer F.

8. (canceled)

9. A method of controlling phytopathogenic fungi and/or undesired plant growth and/or undesired insect or mite attack and/or for regulating the growth of plants, wherein the composition according to claim 1 is allowed to act on the respective pests, their environment or the crop plants to be protected from the respective pest, on the soil and/or on undesired plants and/or on the crop plants and/or on their environment.
